(19) United States
(12) Patent Application Publication
(10) Pub. No.: US 2012/0166220 A1
(43) Pub. Date: Jun. 28, 2012

(54) PRESENTING QUALITY MEASURES AND STATUS TO CLINICIANS

(75) Inventors: Lynn Baldwin, Kansas City, MO (US); Hugh Ryan, Lee's Summit, MO (US); Donna J. Cappo, Independence, MO (US)

(73) Assignee: CERNER INNOVATION, INC., Overland Park, KS (US)

(21) Appl. No.: 12/976,291

(22) Filed: Dec. 22, 2010

(51) Int. Cl. G06Q 50/00; G06Q 10/00

(52) U.S. Cl. 705/3

(57) ABSTRACT

Methods, systems, and computer-readable medium are provided for generating a user interface that presents quality measures to a clinician in a healthcare system. Quality measures are identified that are applicable to a medical condition of a patient. Data elements that indicate completion of one or more quality measures are also identified in the patient's electronic medical record. A completion status of each of the quality measures is determined based on the data elements. A user interface is generated that provides an indication of the medical condition(s) of the patient, applicable quality measures, and the completion status thereof. The user interface may be presented to a clinician accessing the patient's EMR and may allow the clinician to provide additional data to document completion of a quality measure.

### BACKGROUND

The manner in which healthcare systems are reimbursed for services rendered to patients is evolving. This is especially true for government funded health insurance programs such as, Medicare and Medicaid, and may eventually reach into the private insurance sector. Historically, healthcare systems, e.g. hospitals and clinics, were paid based on the services rendered. If a patient was given a procedure, the healthcare system was reimbursed for the procedure. Currently, however, many studies and pilot programs are underway to study alternative criteria on which to base reimbursements paid to healthcare systems. For example, pay-for-performance is one such alternative in which reimbursement for services rendered is based not only on the services themselves, but also on the quality of the care received by the patient. Thus, if a patient received a procedure but mistakes were made that led to additional costs and procedures, the healthcare system might not be fully reimbursed for the procedure or the additional costs.

Many initiatives and organizations have been created by government and private sector entities to study and improve healthcare systems, reporting on quality of services rendered by the healthcare systems, and reimbursement of the healthcare systems. In particular, the Centers for Medicare and Medicaid Services (CMS) and the Joint Commission have created the Specifications Manual for National Hospital Inpatient Quality Measures (hereinafter the “Manual”).

The Manual provides a common set of specifications and documentation that are to be used for collecting and reporting on a set of core medical conditions including heart failure, acute myocardial infarction (AMI), stroke, community acquired pneumonia, venothromboembolism (VTE), children's asthma, and surgery related conditions as identified by the Surgical Care Improvement Project (SCIP). As such, the Joint Commission and the CMS aim to refine and standardize hospital data, data transmission, and performance measures in order to construct a standard quality measure set for hospitals that is widely used by public and private organizations and insurance providers. Additionally, compliance with Medicare and Medicaid reporting requirements and reimbursements provided thereby are also to utilize data reported under the Manual's specifications.

Compliance with the reporting requirements of the Manual is difficult and time consuming due at least in part to the voluminous size and number of data points that are collected and recorded. In order to comply with the reporting requirements under the Manual, healthcare systems must initially setup systems that comply with the Manual and then must digest and implement changes to the Manual that are promulgated every six months.

Compliance with the reporting requirements is also hindered because collection of the required data elements and generation of reports is typically completed by persons other than the clinicians involved in the patient's care and after a patient is discharged from the healthcare system. Thus, problems arise with illegible or missing documentation of data elements. Additionally, the clinicians involved in the patient's care are not aware of all of the specific data elements contained in the more than 400 pages of the data dictionary that are required for reporting and may not know to document such data. And the clinicians may not have incentive to actively pursue reporting because, compliance with the reporting requirements of the Manual effects reimbursements provided to the healthcare system but, not the individual clinician.

### SUMMARY

Embodiments of the invention are defined by the claims below, not this summary. A high-level overview of various aspects of the invention are provided here for that reason, to provide an overview of the disclosure, and to introduce a selection of concepts that are further described below in the detailed-description section below. This summary is not intended to identify key features or essential features of the claimed subject matter, nor is it intended to be used as an aid in isolation to determine the scope of the claimed subject matter.

Embodiments of the invention include systems, methods, and computer-readable media for identifying and presenting quality measures associated with a medical condition of a patient to a clinician. The clinician is provided with a listing and description of the quality measures that apply to the patient, a completion status of the quality measures, and a way to document completion or to order actions to complete the quality measures.

In an embodiment, a patient is admitted to a healthcare system. Data elements associated with the patient and the patient's care (patient data) are entered into the patient's electronic medical record (EMR), now EMR data. A medical condition of the patient is diagnosed or identified from the EMR data. A quality measure that is associated with the medical condition is identified and a completion status of the quality measure is determined based on the EMR data. Clinicians accessing the patient's EMR are presented with a user interface that provides indications of the patient's medical condition, the quality measure associated therewith, and the completion status of the quality measure. The clinicians may interact with the user interface to be provided with a description of the quality measure, a link to a form on which to document completion of the quality measure or a reason for non-completion of the quality measure, and a link to an order writing form or application in which to place an order for the patient.

### DESCRIPTION OF THE DRAWINGS

Illustrative embodiments of the invention are described in detail below with reference to the attached drawing figures, and wherein:

FIG. 1 is a block diagram depicting an exemplary operating environment suitable for use in accordance with an embodiment of the invention;

FIG. 2 is a block diagram depicting an exemplary network architecture suitable for use in accordance with an embodiment of the invention;

FIG. 3 is a graphical representation of an exemplary electronic medical record presentation in accordance with an embodiment of the invention;

FIG. 4 is a graphical representation of a user interface presenting quality measures that are applicable to medical conditions of a patient in accordance with an embodiment of the invention;

FIG. 5 is a graphical representation of a user interface presenting quality measures that are applicable to acute myocardial infarction in accordance with an embodiment of the invention;

FIG. 6 is a graphical representation of a user interface presenting quality measures that are applicable to heart failure in accordance with an embodiment of the invention;

FIG. 7 is a graphical representation of a documenting interface in accordance with an embodiment of the invention;

FIG. 8 is a graphical representation of an ordering interface in accordance with an embodiment of the invention;

FIG. 9 is a block diagram depicting a system for informing clinicians in a healthcare system of a quality measure that is associated with a patient and a completion status of the quality measure in accordance with an embodiment of the invention;

FIG. 10 is a block diagram depicting a method for tracking completion of quality measures in a healthcare system in accordance with an embodiment of the invention; and

FIG. 11 is a block diagram depicting a component for presenting a quality measure that applies to a patient in accordance with an embodiment of the invention.

### DETAILED DESCRIPTION

The subject matter of embodiments of the invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

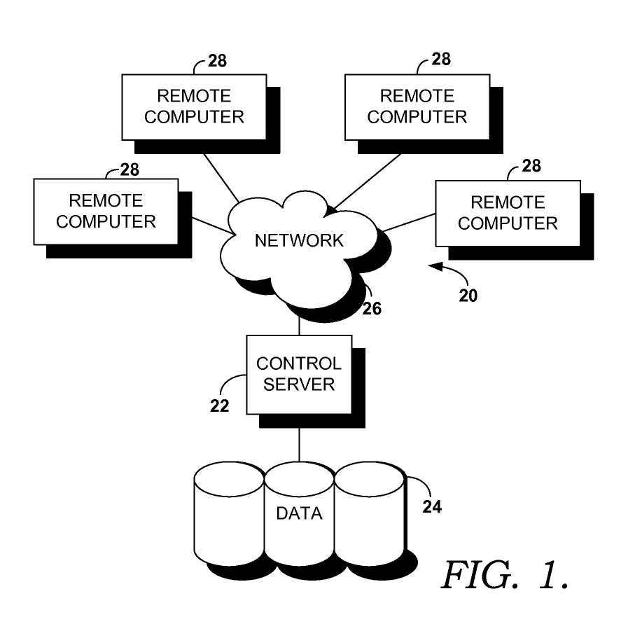

Having briefly described embodiments of the present invention, an exemplary operating environment suitable for use in implementing embodiments of the present invention is described below. Referring to the drawings in general, and initially to FIG. 1 in particular, an exemplary computing system environment, a medical information computing system environment, with which embodiments of the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in association with local and/or remote computer storage media including, by way of example only, memory storage devices.

With continued reference to FIG. 1, the exemplary medical information computing system environment 20 includes a general purpose computing device in the form of a control server 22. Components of the control server 22 may include, without limitation, a processing unit, internal system memory, and a suitable system bus for coupling various system components, including database cluster 24, with the control server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 22 typically includes therein, or has access to, a variety of computer-readable media, for instance, database cluster 24. Computer-readable media can be any available non-transitory media that may be accessed by server 22, and includes volatile and nonvolatile media, as well as removable and non-removable media. By way of example, and not limitation, computer-readable media may include computer storage media. Computer storage media may include, without limitation, volatile and nonvolatile media, as well as removable and non-removable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 22. Combinations of any of the above also may be included within the scope of computer-readable media.

The computer storage media discussed above and illustrated in FIG. 1, including database cluster 24, provide storage of computer-readable instructions, data structures, program modules, and other data for the control server 22. The control server 22 may operate in a computer network 26 using logical connections to one or more remote computers 28. Remote computers 28 may be located at a variety of locations in a medical or research environment, for example, but not limited to, clinical laboratories (e.g., molecular diagnostic laboratories), hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as neonatologists, surgeons, radiologists, cardiologists, and oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 28 may also be physically located in non-traditional medical care environments so that the entire health care community may be capable of integration on the network. The remote computers 28 may be personal computers, servers, routers, network PCs, peer devices, other common network nodes, or the like, and may include some or all of the elements described above in relation to the control server 22. The devices can be personal digital assistants or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the control server 22 may include a modem or other means for establishing communications over the WAN, such as the Internet. In a networked environment, program modules or portions thereof may be stored in association with the control server 22, the database cluster 24, or any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., control server 22 and remote computers 28) may be utilized.

In operation, a clinician may enter commands and information into the control server 22 or convey the commands and information to the control server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 22. In addition to a monitor, the control server 22 and/or remote computers 28 may include other peripheral output devices, such as speakers and a printer.

Although many other internal components of the control server 22 and the remote computers 28 are not shown, those of ordinary skill in the art will appreciate that such components and their interconnection are well known. Accordingly, additional details concerning the internal construction of the control server 22 and the remote computers 28 are not further disclosed herein.

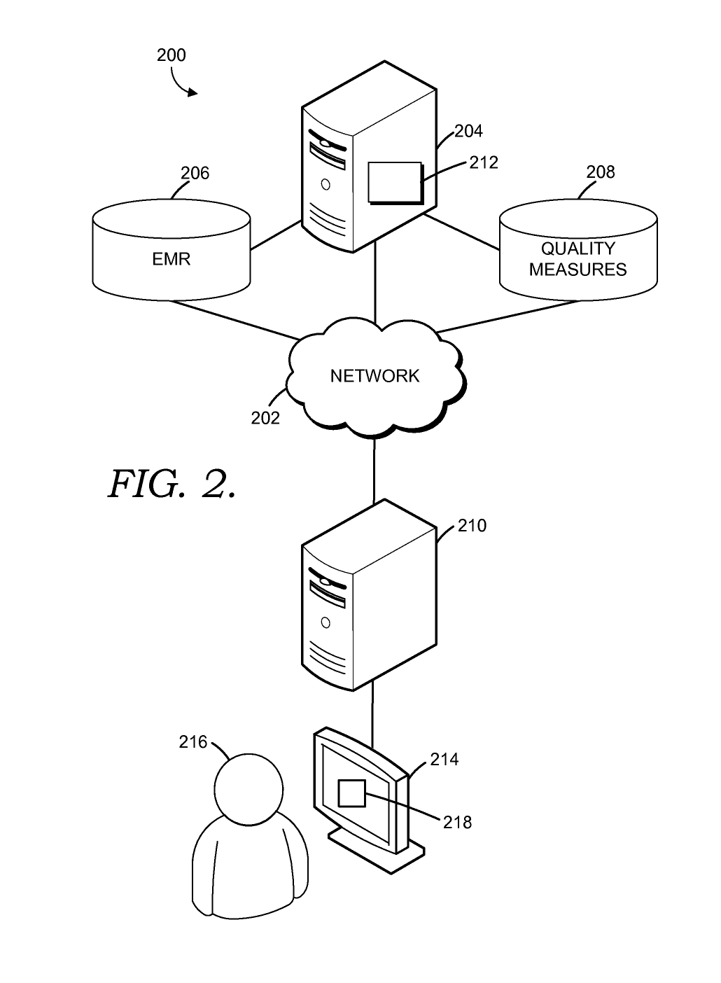

With additional reference now to FIG. 2, an exemplary network architecture 200 suitable for use in embodiments of the invention is described. The network architecture 200 may reside within or comprise a medical information computing system environment 20 described above. The network architecture 200 is one example, of which there are many, that can be used to implement embodiments of the invention. Components of the network architecture 200 are depicted singularly for clarity but, in practice, may include a plurality of similar or dissimilar components that are configured to perform the functions described below. Additionally, one or more of the components or the functions thereof can be integrated into a single component or further divided into a plurality of subcomponents. The network architecture 200 is not intended to limit components or network architectures that can be employed in embodiments of the invention. One of skill in the art will recognize other components and architectures that are suitable for use in embodiments of the invention.

The network architecture 200 includes a network 202, a network computing device 204, an Electronic Medical Record (EMR) database 206, a quality measures database 208, and a user's computing device 210. The network 202 includes any available network, such as for example, an intranet, the Internet, an Ethernet, a local area network, and the like as described above. In an embodiment, the network 202 is a secure local area network of a healthcare system such as a hospital.

The network computing device 204 is any one or more computing device(s), such as the control server 22, described above. The network computing device 204 is communicatively coupled either directly or indirectly to the network 202, the EMR database 206, and the quality measures database 208. The network computing device 204 is configured to receive patient data, e.g. data related to a patient or to the care of the patient, and to store such data in the ERM database. The patient data is supplied to the network computing device 204 by users in a healthcare system via the network 202 or directly to the network computing device 204. The users include clinicians, hospital administrative users, and the like.

In an embodiment, the network computing device 204 also includes algorithms, procedures, or rules for determining one or more medical conditions of a patient based on the patient data received thereby. Or medical conditions can be specified by clinicians and input to the network computing device 204 thereby. The determined or received medical conditions are also stored to the EMR database 206.

Additionally, the network computing device 204 is configured via one or more applications or components 212 to identify patient medical conditions that are core medical conditions on which reporting of patient data associated therewith is required by governmental or private organizations or is desired by the healthcare system. In an embodiment, the core medical conditions are set forth by the Joint Commission and the Centers for Medicare and Medicaid Services (CMS) in the Specifications Manual for National Hospital Inpatient Quality Measures (hereinafter the “Manual” and which is hereby incorporated by reference herein) as published by the Joint Commission at www.jointcommission.org. For example, the core medical conditions might include heart failure, acute myocardial infarction (AMI), stroke, community acquired pneumonia, venothromboembolism (VTE), children's asthma, and surgery related conditions as identified by the Surgical Care Improvement Project (SCIP).

Along with identifying core medical conditions, the component 212 is also configured to identify one or more quality measures that are associated with the core medical condition and one or more data elements from the EMR database 206 that indicate completion or incompletion of the quality measures. In an embodiment, the quality measures and the associated data elements are set forth in the Manual.

The Manual is updated biannually and includes a data dictionary, measure information forms, algorithms, and the like. The data dictionary describes the patient-level data elements required to capture and calculate individual measurements and specifies the data elements that must be collected for each patient on which reporting is required, e.g. a patient that has a core medical condition for which quality measures are provided by the Manual. The data dictionary alone in Version 3.2c of the Manual (available at the Joint Commission's website www.jointcommission.org), which is applicable from Oct. 1, 2010 through Mar. 31, 2011 comprises over 400 pages of text.

Quality measures include activities or events that have been determined necessary or desired in the care of a patient to ensure that the care provided to the patient is of at least a standard quality level. For example, it might be determined that providing aspirin to a patient suffering from an AMI greatly decreases their risk of generating additional clots and, as such, a quality measure might be provided that requires such provisioning of aspirin to AMI patients within 24 hours of being admitted to a hospital. The completion or compliance with the quality measures is used by organizations such as the Joint Commission and CMS to determine whether a healthcare system is performing adequately and may be used as a basis for providing reimbursement to the healthcare system. Specific sets of quality measures are provided for each of the core medical conditions; each of the sets may include one or more overlapping quality measures.

The data elements associated with the quality measures include patient data that is input and stored in the EMR database 206 for a given patient. The data elements are stored in the EMR database in any manner. In an embodiment, the data elements are identified by the component 212 on the network computing device 204 and are extracted or copied to another storage location. The data elements include patient data that at least partially indicates completion or non-completion of at least one quality measure that is associated with the given patient's medical condition. For instance, a data element or elements can indicate that a quality measure has not been completed, has been completed, or that the quality measure has intentionally not been completed for a given reason, e.g. a quality measure might require provision of a medication to which the patient is allergic and, thus, the quality measure has not been completed because of the allergy.

The data elements might also indicate that a quality measure has been partially completed but that one or more specific data element values are missing or are unacceptable to complete the quality measure and/or comply with requirements for documenting completion of the quality measure. For example, a quality measure may include a time requirement that indicates when the quality measure must be completed. Data elements associated with the quality measure might indicate that the time for completion has elapsed but acceptable values of the data elements indicating completion of the quality measure are not available. Thus, the data elements indicate that the quality measure is complete but the requirements for documenting the completion are not met.

For instance, using the above example for a quality measure that requires provisioning of aspirin within 24 hours of admission, the data elements associated with the quality measure might indicate that 24 hours have passed since admission of a patient but, the data elements do not indicate that aspirin was given to the patient. Thus, the data elements indicate that the quality measure is incomplete and the required documentation of the completion is not provided. Such a completion status of a quality measure is referred to herein as “complete-incomplete.”

In an embodiment, the component 212 is configured to abstract patient data that is input to the EMR database 206 to determine and identify qualifying data that represents completion of, or documentation of the completion of a quality measure. Abstraction of the data includes utilizing relationships between associated data elements, characteristics of the data elements, and the like.

The quality measures and indications of the data elements that are associated therewith are stored in the quality measures database 208. One or more data structures or other indications may be employed in the quality measures database 208 that indicate quality measures that are associated with a given medical condition. The quality measures database 208 also includes indications of data elements that are associated with each quality measure as well as locations in the EMR database 206 where values for the data elements are stored. Additionally, data formats and acceptable data element value characteristics, among other information regarding the data elements are also provided in the quality measures database 208. In an embodiment, the data structures, contents, and arrangements thereof in the quality measures database 208 is based on the Manual and the data dictionary provided thereby. In an embodiment, the quality measures database 208 is integral with the EMR database 206 and/or the network computing device 204.

With continued reference to FIG. 2, the network architecture 200 also includes the user's computing device 210. The user's computing device is any available computing device, such as the control server 22 or the remote computers 28 of FIG. 1. In an embodiment, the user's computing device 210 and the network computing device 204 are the same computing device. The user's computing device 210 is communicatively coupled to the network 202 and thereby to the network computing device 204, the EMR database 206 and the quality measures database 208. The user's computing device 210 includes an associated display device 214 and is operated by a user or clinician 216. The display device 214 is any display device available in the art suitable for providing a display to the clinician 216 of a user interface 218, as described more fully below.

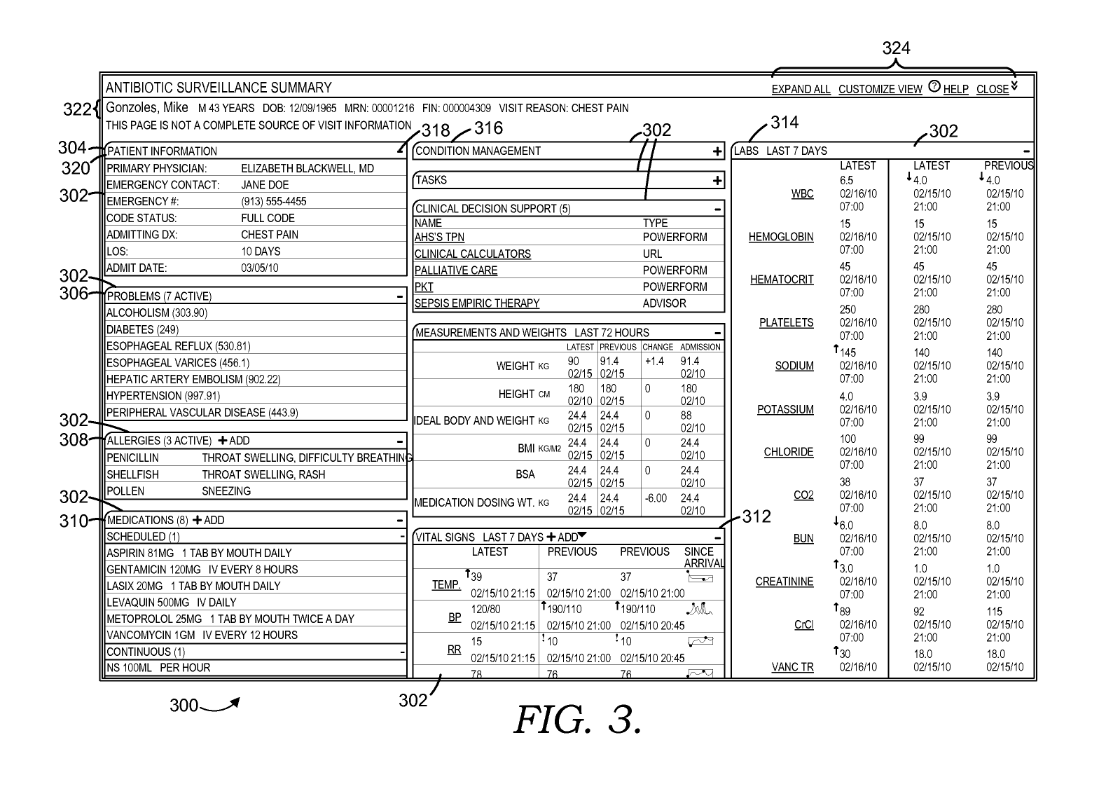

The user's computing device 210 is employed by the clinician 216 to access and interact with an EMR for a patient. An EMR is an electronic version of a patient's medical record or chart as is known in the art. The EMR presents patient data for a respective patient that is stored in the EMR database 206 and allows clinicians 216 to input, alter, access, or otherwise interact with the patient data. The EMR is provided by any available applications and in any desired format known in the art. In an embodiment, the EMR is presented in a web page-style format and includes an initial page or portal that is presented to the clinician 216 upon accessing the EMR, such as depicted in FIG. 3. Such an EMR presentation may employ hypertext markup language (HTML), Java script, or any other available coding. In an embodiment, the portal page is an “M-page” as provided by software solutions developed by the Cerner Corporation, of Kansas City, Mo.

As depicted in FIG. 3, an embodiment of a portal page 300 of an EMR for a fictitious patient, Mike Gonzoles is depicted. The portal page 300 is one example of a presentation of an EMR for a patient and is not intended to limit the scope of embodiments of the invention; one of skill in the art will recognize various other arrangements, elements, and presentations that might be employed in presenting or accessing a patient EMR. The portal page 300 is configured in a web page-style format and provides an overview of a selection of patient data. In an embodiment, the portal page 300 provides a selection of the most recent and/or most pertinent patient data related to the current care of the patient. As such, the portal page 300 may be an initial page provided to a clinician 216 when first accessing a patient's EMR. This provides the clinician with a quick overall impression of the patient's status and important patient data with respect thereto. The portal page 300 may provide a variety of links or access features to aid the clinician 216 in navigating to other portions of the EMR or other applications for viewing additional patient data, documenting events in the patient's care, and placing orders for additional actions, medications, and the like, among other tasks.

The portal page 300 includes a number of subsections 302 that each represent a different category of information and provide respective patient data associated with the respective category. For example, the subsections might represent categories such as general Patient Information 304, Problems 306, Allergies 308, Medications 310, Vital Signs 312, Labs 314, Condition Management 316, and the like. The patient data provided in each of the subsections 302 can be organized, collected, and presented in any desired way. Each of the subjections can be expanded or minimized to view or hide the patient data included therein by selecting an icon 318 in a title bar 320 thereof. For example, the Patient Information 304 subsection is expanded while the Condition Management 316 subsection is minimized.

The portal page 300 also includes a header portion 322 that provides additional patient data such as name, age, and reason for a current visit. The header portion 322 may include one or more additional features 324 or indications for customizing the view, accessing a help menu, closing the portal page 300, and the like.

The presentation of the EMR via the user interface 218 provides visual indications of medical conditions of a patient, quality measures that apply thereto, and a completion status of the quality measures as determined by the component 212. Thus, a clinician 216 viewing the EMR of a patient that has a medical condition to which one or more quality measures apply is presented with indications of these facts and is made aware of actions that have been taken or that need to be taken to complete the quality measures for the patient. Additionally, the user interface 218 may provide functionality to allow the clinician 216 to document actions that have been taken or reasons for not taking the actions as well as functionality to provide orders for such actions.

As such, the clinician 216 is provided with information regarding the quality measures during the patient's stay in the hospital or healthcare system and can provide the necessary data elements for documenting completion of quality measures that apply to the patient's medical condition. Thus, the information is collected at a time when it is fresher in the mind of the clinician 216 rather than at a time post-discharge when the clinician 216 may not remember the information or when it is too late to gather or determine the information. Also, by making the clinician 216 aware of the necessary information the likelihood that such information will be documented is increased.

In contrast, if a clinician is unaware of specific information that is needed to document completion of a quality measure, the clinician may complete all of the actions necessary to complete the quality measure but may unknowingly fail to document all of the necessary data. Thus, the healthcare system is not able to submit a claim for reimbursement or may not be fully reimbursed for services that were rendered to a respective patient in full compliance with the quality measures because the proper documentation is not available.

In an embodiment, the user interface 218 and/or the component 212 are configured to provide a warning prior to discharge of a patient when one or more quality measures that apply to the medical condition of the patient are incomplete or complete-incomplete. The warning may be a visual and/or audible alert that is provided via the EMR of the patient or may be provided at another location or interface of the healthcare system's network 202. In another embodiment, the user interface 218 and/or the component 212 restricts a patient from being discharged when one or more quality measures that apply to a medical condition of the patient are incomplete or complete-incomplete. For example, the component 212 might deny entry of final discharge data into the EMR until all of the quality measures applicable to the patient's medical condition have a complete status. Such warnings and restrictions may be desired by a healthcare system that wishes to achieve complete reporting on core medical conditions and/or to receive a maximum reimbursement based on such reporting.

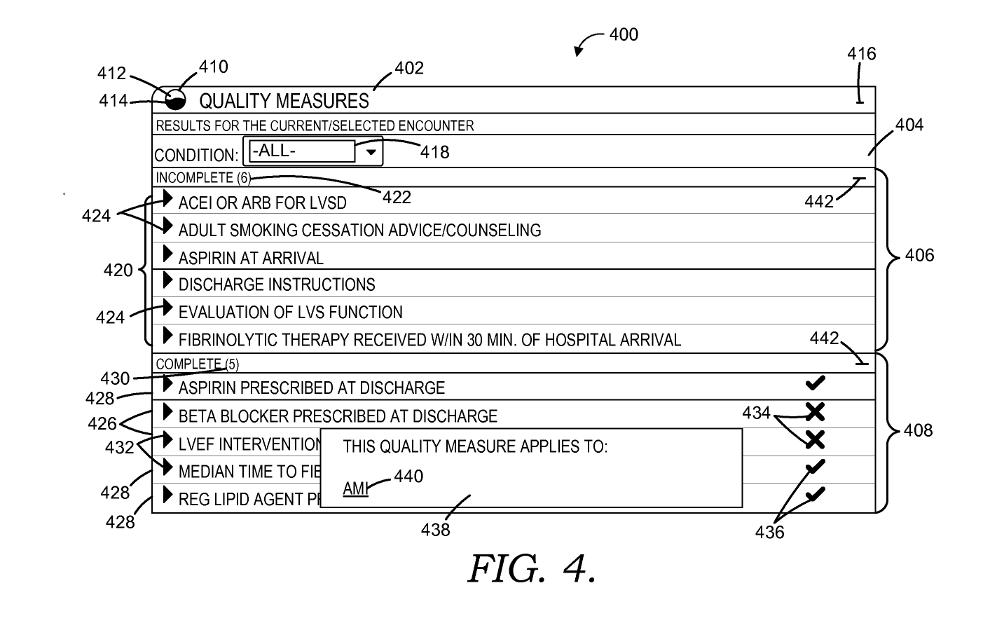

An exemplary user interface 400 is depicted in FIGS. 4, 5, and 6. The user interface 400 depicted in FIGS. 4-6 is intended to illustrate one example of the user interface 218, however, one of skill in the art will recognize that many alternative visual forms of the user interface 218 may be created that include various similar or dissimilar elements that provide similar functionalities without departing from the scope of embodiments of the invention described herein. As depicted in FIGS. 4-6, the user interface 400 visually resembles or is similar to a subsection 302 of the portal page 300 of FIG. 3. The user interface 400 includes a title bar 402 along a top portion thereof as well as a condition bar 404, an incomplete section 406, and a complete section 408.

The title bar 402 includes an indicator 410 that provides a quick reference of a level of completion of the quality measures for the patient. In an embodiment, the indicator 410 is circular in shape and has a background color 412 and a fill color 414. When no quality measures for a patient are complete the indicator 410 is completely colored in the background color 412 (as depicted at 602 in FIG. 6). When all of the quality measures for the patient are completed the indicator 410 is completely filled by the fill color 414. When the quality measures for the patient are only partially completed the indicator 410 is partially filled by the fill color 414; the amount of fill may be proportional to the percentage of quality measures that have been completed or may be simply fill a designated portion of the indicator 410.

The title bar 402 also includes an icon 416, similar to the icons 318 in FIG. 3, for expanding or minimizing the display of the user interface 400. For example, when the user interface 400 is minimized only the title bar 402 is visible. In the minimized form the indicator 410 provides a quick reference to a clinician 216 for determining a general status of quality measure completion.

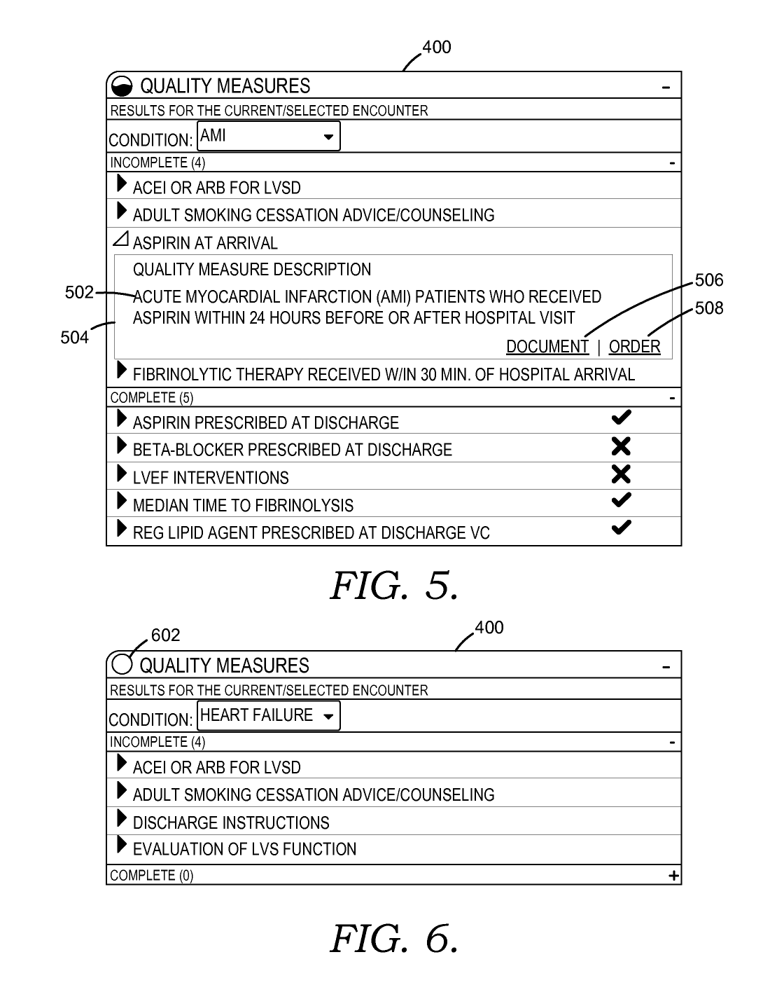

The condition bar 404 provides a selection menu 418 for selecting a group of quality measures to be displayed by the user interface 400 based on medical conditions of the patient to which quality measures apply. The selection menu 418 may comprise a drop down menu as depicted in FIG. 4 that allows a user to select between viewing quality measures for all medical conditions of the patient having applicable quality measures or just viewing quality measures that apply to a single medical condition. For example FIG. 4 depicts quality measures for “ALL” medical conditions, FIG. 5 depicts quality measures for only “AMI,” and FIG. 6 depicts quality measures for “Heart Failure.”

The incomplete section 406 of the user interface 400 provides a listing of quality measures 420 for the patient that are currently incomplete. As described previously, incomplete quality measures 420 are those for which no qualifying patient data is available the EMR database 206 that applies or relates to the quality measure or that indicates at least partial completion of the quality measure. The incomplete quality measures 420 are populated in the user interface 400 by the component 212 as described above. The incomplete section 406 may also provide a numeric indication 422 of a number of incomplete quality measures 420.

Also, an expandable tab 424 might also be provided for each incomplete quality measure 420. With additional reference to FIG. 5, the expandable tab 424 may be selected to expand the listing of the incomplete quality measure 420 to display a description 502 of the incomplete quality measure 420, now an expanded listing 504. In an embodiment, the description 502 includes text provided by the Manual, and indicates to a reader/the clinician 216 additional information about the quality measure, to what or to whom it may apply, and why, among other available information.

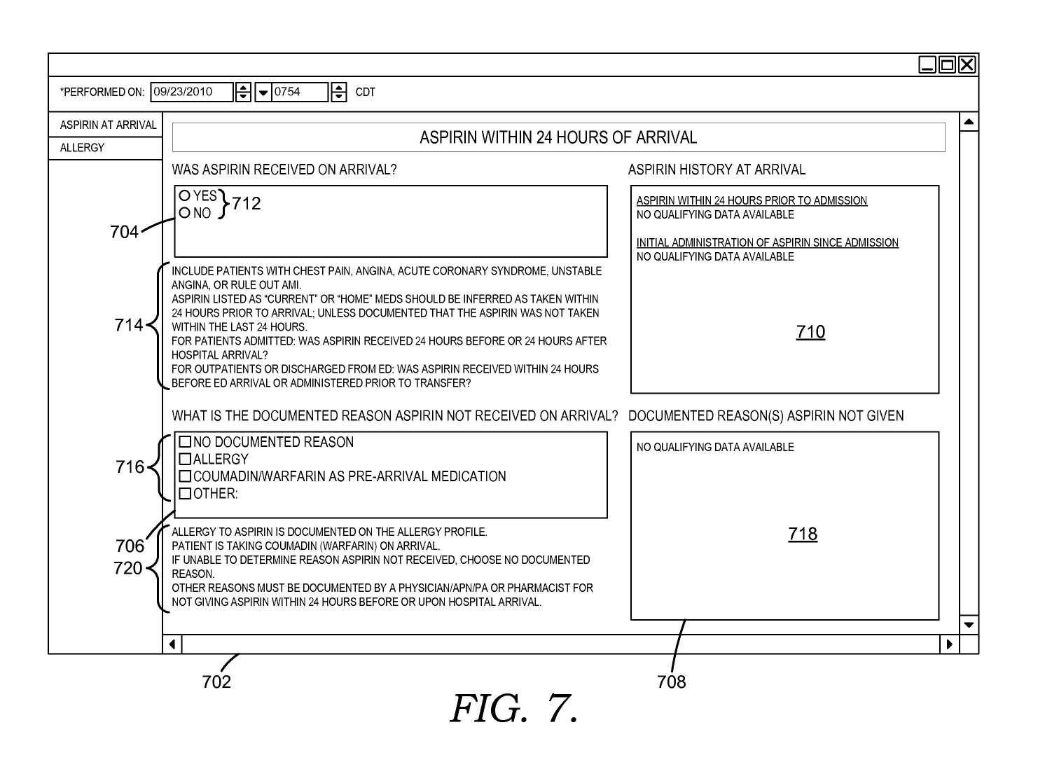

The expanded listing 504 also provides one or more links such as a Document link 506 and an Order link 508. The links 506 and 508 allow a clinician 216 to navigate to other portions of the patient's EMR, or to other applications, components, web pages, or the like. In an embodiment, the Document link 506 allows the clinician 216 to navigate to a documenting interface 700 such as an application, web page, or the like for documenting patient data associated with the respective incomplete quality measure 420, as depicted in FIG. 7. In an embodiment, the documenting interface 700 is a PowerForm provided by the Cerner Corporation of Kansas City, Mo.

The documenting interface 700 may be designed or formatted in any way desired and may include various elements for providing information regarding the incomplete quality measures 420, patient data, or other desired information. The documenting interface 700 depicted in FIG. 7 and described herein is but one exemplary interface of which one of skill in the art will recognize there are many. The documenting interface 700, or interface 700, includes a title bar 702 that indicates the incomplete quality measure 420 to which the interface 700 applies. The interface 700 also includes a completion selection section 704, a non-completion section 706, a free-text section 708, and a qualifying patient data section 710.

The completion selection section 704 provides one or more selectable options 712 that are acceptable for documenting completion of the respective incomplete quality measure 420. Additional information 714 regarding the quality measure and/or the acceptable options 712 may also be associated with the completion selection section 704. Upon selection of one or more of the selectable options 712 (and completion of any other steps for completing documentation of patient data), an indication of the selection is added to the EMR of the patient and to the EMR database 206. Additionally, the component 212 may move the incomplete quality measure 420 to the complete section 408 of the user interface 400.

The non-completion section 706 provides one or more selectable reasons 716 that the clinician 216 may use to document the intentional non-completion of the respective incomplete quality measure 420. For example, the clinician 216 might intentionally not complete a quality measure that requires providing a drug to which the patient is allergic. One or more of the selectable reasons 716 may necessitate additional information and documentation from the clinician 216 or the clinician may desire to provide further documentation. Such additional information may be provided in the free-text section 708 which allows entry of text into a form or field 718. The text or the field 718 is configured to be capable of entry into the EMR for the patient and the EMR database 206. And the text or field 718 is abstractable by the component 212 for determining whether the provided information is acceptable to indicate completion of the respective incomplete quality measure 420. Additional information 720 might also be provided in association with the non-completion section 706 to inform the clinician 216 and/or aid in selecting an appropriate reason 716 or supplying appropriate free-text documentation.

The interface 700 further includes the qualifying patient data section 710. This section 710 provides any desired patient data that relates to the respective incomplete quality measure 420. The section 710 might also indicate what patient data is missing or is required to complete the respective incomplete quality measure 420.

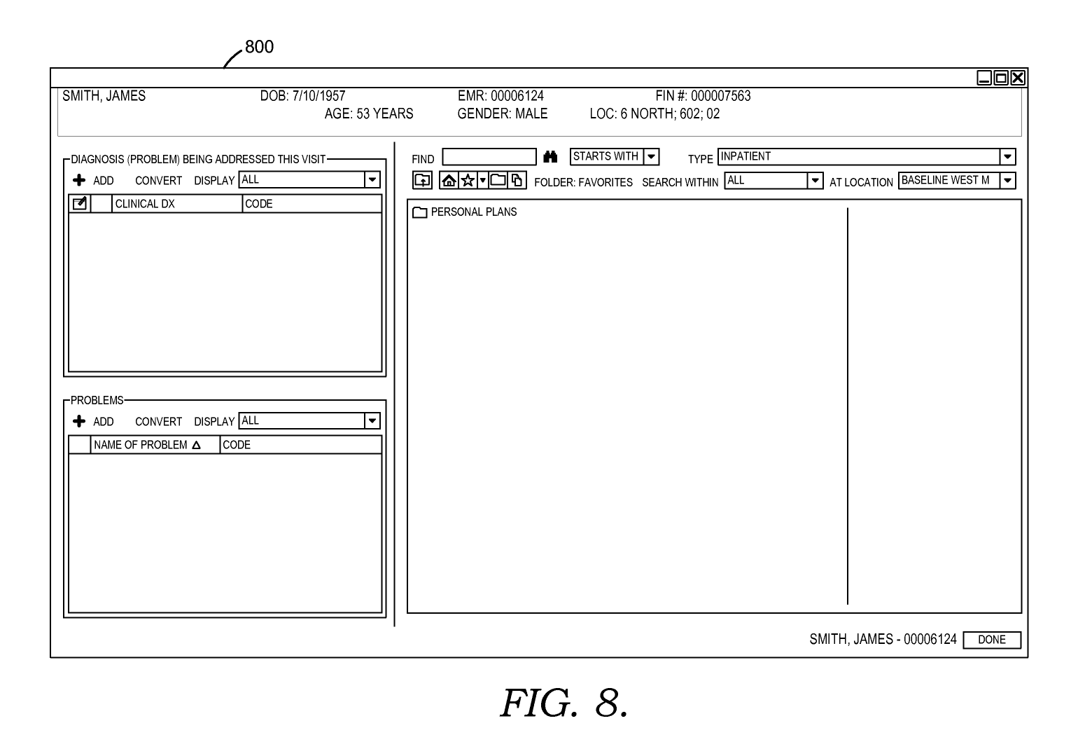

With continued reference to FIG. 5, the Order link 508 allows the clinician 216 to navigate to an order generating interface 800 depicted in FIG. 8, such as an application, web page, or the like for ordering procedures, medications, or other services for a patient. In an embodiment, the order generating interface 800 is provided by the Cerner Corporation of Kansas City, Mo.

The ordering interface 800 may include various elements for providing patient information, medication information, and orders for procedures or treatments for the patient as is known in the art. The order generating interface 800 depicted in FIG. 8 and described herein is but one exemplary interface of which one of skill in the art will recognize there are many.

Returning to FIG. 4, the complete section 408 of the user interface 400 includes many similar elements as described above for the incomplete section 406, however, the complete section 408 includes a listing of complete-incomplete 426 and/or complete quality measures 428. The complete section 408 includes a numeric indicator 430 and expandable tabs 432 similar to the numeric indicator 422 and expandable tab 424 described above. Additionally, when expanded, the expandable tabs 432 also provide similar information and links to the documenting interface 700 and the order interface 800.

A unique aspect of the complete section 408 is a compliance indicator 434 and 436 for each of the complete 428 quality measures listed in the complete section 408. As depicted in FIG. 4, a different compliance indicator 434, 436 is provided to differentiate whether the quality measure compliance has been met or not met. In an embodiment, the compliance indicator 434, 436 will not be displayed in the incomplete section 406 because, as described above, complete-incomplete quality measures 426 are quality measures for which one or more data elements are available in the EMR database 206 that indicate at least partial completion of the respective quality measure, but, that are missing one or more other data elements that are required to document such completion and therefore, a met or not met status cannot be determined. As such, a clinician 216 is able to quickly identify quality measures that are complete 428 and those that need additional documentation, e.g. are complete-incomplete 426. As described above with respect to the incomplete quality measures 420, a clinician 216 may expand a listing for a complete-incomplete quality measure to access a link (not shown) to the documenting interface 700 or the order generating interface 800 to complete the requirements of the complete-incomplete quality measure 426. A clinician 216 might also access the interfaces 700 and 800 for a complete quality measure 428 to provide additional documentation as desired.

With continued reference to FIG. 4, the user interface 400 also includes functionality to inform the clinician of medical condition(s) to which each of the listed incomplete 420, complete-incomplete 426, and complete 428 quality measures apply. It is noted that a quality measure 420, 426, 428 may apply to more than one medical condition. For example, a clinician 216 may hover a pointer, cursor, or other selection device as is known in the art, over a listed quality measure 420, 426, 428 to reveal a popup window 438. The popup window 438 provides an indication 440 of a medical condition(s) to which the hovered over quality measure 420, 426, 428 applies. Alternatively, other input methods known in the art, such as a right click of a mouse button might be employed to reveal the popup window 438. Additionally, the incomplete 406 and complete 408 sections of the user interface may include a selectable icon 442 that allows the section 406, 408 to be minimized or expanded.

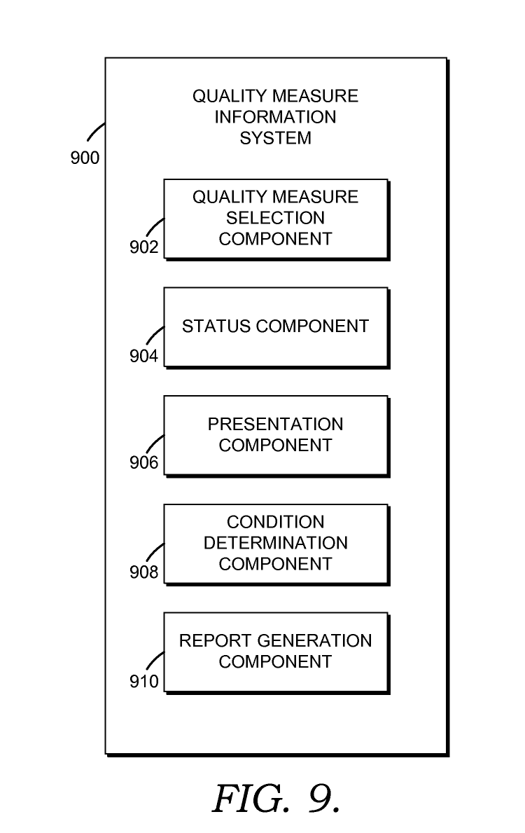

With reference now to FIG. 9, a quality measure information system 900 for informing clinicians in a healthcare system of a quality measure that is associated with a patient and a completion status of the quality measure is described in accordance with an embodiment of the invention. The system 900 includes a quality measure selection component 902, a status component 904, a presentation component 906, and may optionally include a condition determination component 908 and a report generation component 910.

The quality measure selection component 902 is configured to receive or access patient data stored in an EMR record in an EMR database and to determine one or more quality measures that are applicable to a medical condition of a patient. The patient's medical condition may be indicated by the patient data or the component 902 can determine the medical condition based on the patient data. The quality measure selection component 902 includes data structures, procedures, algorithms, or other information for determining the quality measures that are applicable to the medical condition of the patient. In an embodiment, the identification of the applicable quality measures is instructed by the Manual.

The quality measure selection component 902 is also configured to identify data elements that, when acceptable values for which are provided, indicate completion of one or more of the quality measures. The identification of the data elements is also instructed by the data structures, procedures, algorithms, or other information. The data elements can include required data elements as well as optional data elements that represent one or more alternative pieces of patient data that are useable to document completion of a respective quality measure. As such, the component 902 identifies or has knowledge of relationships between the data elements and abstractions thereof that are useable to identify and document completion of a respective quality measure.

The status component 904 is configured to determine a completion status of the one or more quality measures based on values provided for the data elements. The status component 904 employs knowledge of required data elements and the relationships between the data elements described above to determine whether patient data input to the EMR database for the data elements is sufficient to document completion of a respective quality measure. Based on this determination, the status component 904 identifies each of the quality measures associated with the patient's medical condition(s) as incomplete, complete-incomplete, or complete.

The presentation component 906 is configured to generate a user interface, such as the user interfaces 218 and 400 described above, for presenting the medical condition(s) of a patient that are associated with one or more quality measures, indications of the quality measures, and an indication of a completion status of each of the quality measures. The presentation component 906 inserts the user interface into a presentation or visualization of the patient's EMR that is provided to a clinician upon accessing the patient's EMR. In an embodiment, the presentation of the patient's EMR is provided in a web page-style format and employs an initial portal page. The user interface may be inserted into the portal page in a highly visible and conspicuous location, to increase the likelihood of a clinician noticing and utilizing the user interface to document completion of quality measures. In an embodiment, the user interface is presented in a top center location of a portal page.

The condition determination component 908 may optionally be included in the system 900. The component 908 is configured to determine one or more medical conditions of a patient based on patient data in the patient's EMR and the EMR database. The component 908 may utilize any algorithms, data structures, or other information to determine an appropriate medical condition(s). Additionally, the medical condition(s) might be determined based on a diagnosis by a clinician that is documented in the patient's EMR.

The report generation component 910 may also optionally be included in the system 900. The report generation component 910 is configured to collect and organize patient data from the patient's EMR and the EMR database that documents completion of the quality measures associated with a patient. The component 910 may also collect any other desired data for the patient, the medical condition, treatments provided, and the like. A report is generated by the component 910 from the collected data and may be communicated to one or more parties for storage, review, analysis, and the like. The report might be configured to conform to requirements of third party governmental or private sector organizations such as, for example and not limitation, the Joint Commission and the CMS.

In an embodiment, the system 900 is configured to comply with and implement reporting on core medical conditions as required by the Joint Commission and the CMS as set forth in the Manual. As such, the system 900 implements the requirements of the Manual by automatically identifying appropriate medical conditions, quality measures, and data elements that are required for complying with reporting requirements. The system 900 presents clinicians with a straightforward presentation of medical conditions of a respective patient that have applicable quality measures, indications of those quality measures, and a completion status of those quality measures and the documentation thereof. Thereby, the clinician is no longer required to have independent knowledge of the specific reporting requirements and may easily identify actions the need to be completed and documentation that is required. And the clinician is not required to be cognizant of changes to the reporting requirements that are issued biannually.

Further, by providing clinicians with the user interface, the system may increase reporting and documentation of completion of quality measures during the patient's stay in the healthcare system. Thus, the requirement for such reporting to be completed after discharging the patient, and the prevalence of lost or missing data is greatly reduced. Accordingly, healthcare systems are better enabled to accurately and competently report on the quality measures and to achieve a maximum level of reimbursement that is tied to such reporting.

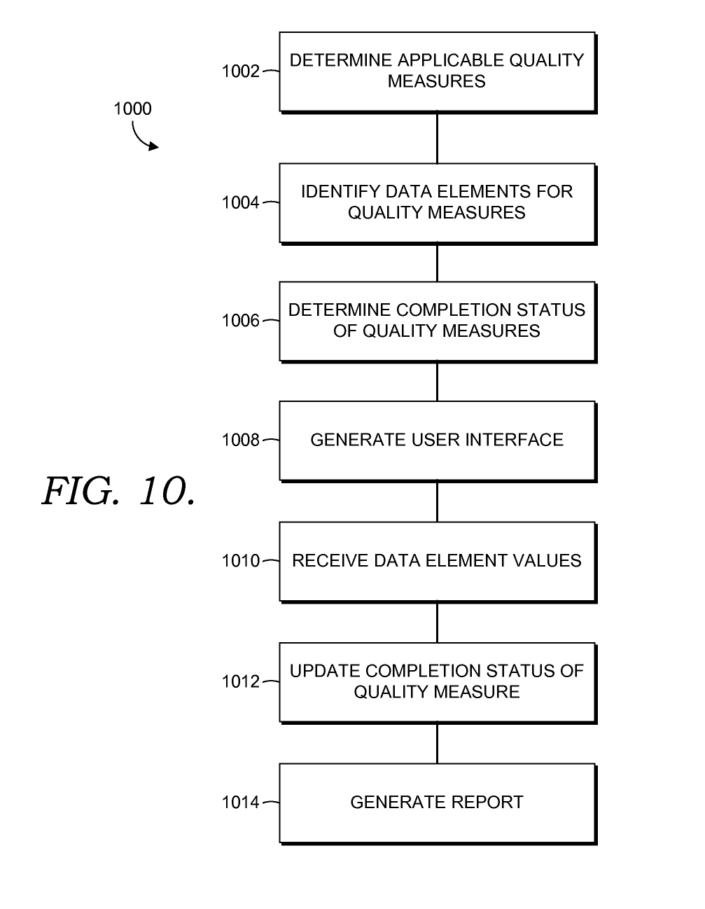

Turning now to FIG. 10, a method 1000 for tracking completion of quality measures in a healthcare system is described in accordance with an embodiment of the invention. At a step 1002, one or more quality measures that are applicable to a medical condition of a patient are determined. Data elements are identified that can indicate completion of one or more of the quality measures when acceptable values are provided, at a step 1004. Based on values input to the patient's EMR for one or more of the data elements, a completion status of each of the quality measures is determined, at a step 1006. A user interface is generated that includes indications of the one or more quality measures and the completion status thereof, at a step 1008. The user interface is provided to a clinician that is accessing the EMR for the patient. Thereby, the clinician is provided with knowledge of applicable quality measures and the completion status thereof via a commonly used and familiar access point, the patient's EMR.

The method 1000 may also include receiving values for the data elements or documentation of completion of one or more of the quality measures via the user interface, as indicated at a step 1010. Following this, the completion status of the quality measures is reevaluated and updated, at a step 1012. Further, at a step 1014 a report is generated from the data elements associated with quality measures, the medical condition, and the patient for reporting to parties within the healthcare system and/or to third party governmental or private organizations.

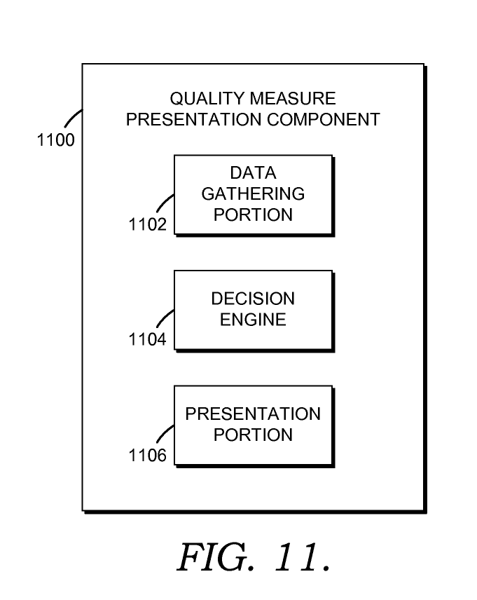

Referring now to FIG. 11, a quality measure presentation component 1100 for presenting a quality measure that applies to a patient is described in accordance with an embodiment of the invention. The component 1100 is configured to provide clinicians with a highly accessible, easy to use user interface for documenting completion of quality measures as set forth by the Joint Commission and the CMS in the Manual. As such, the component 1100 automatically identifies applicable quality measures for a patient's condition as well as data elements necessary for documenting completion of those quality measures. These identifications are based on the greater than 400 textual page data dictionary included in the Manual and that is updated biannually, as well as the various flow diagrams, data abstractions, equivalent/alternative data nomenclatures, and other requirements set forth therein.

The component 1100 includes a data gathering portion 1102, a decision engine 1104, and a presentation portion 1106. The data gathering portion 1102 includes functionalities to gather data from a patient's EMR and other sources. The data includes information concerning medical conditions of the patient and patient data that is associated with quality measures that are applicable to the medical conditions, among other data. The decision engine 1104 is configured to determine a quality measure that applies to the patient's medical condition and data elements associated with the quality measure that are useable and acceptable to document completion of the quality measure for the patient. The presentation portion 1106 presents a user interface to clinicians accessing the patient's EMR that includes an indication of the patient's medical condition(s), quality measures that are applicable thereto, and a status of completion of each of the quality measures.

In an embodiment, the component 1100 is configured to be portable. In other words, the component 1100 may be implemented or inserted into a variety of interfaces or access points. For example, the component 1100 might be inserted into the documenting interface 700 described above such that the user interface generated by the presentation portion 1106 is displayed in the documenting interface 700, or the component 1100 might be inserted into various other interfaces or access points of a patient's EMR, a healthcare system's network, or a third party's computing systems, among others.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A system for informing clinicians in a healthcare system of a quality measure that is associated with a patient and a completion status of the quality measure, the system comprising:
a quality measure selection component that identifies a quality measure associated with a patient based at least in part on a medical condition of the patient and that identifies one or more data elements associated with the quality measure that must be provided to complete the quality measure, wherein the quality measure includes an action to be completed by a clinician for the patient;
a status component that determines, via a computing device having a processor and a memory, a completion status of the quality measure based at least on data stored in the patient's electronic medical record; and
a presentation component that presents a user interface that includes indications of the quality measure and the completion status of quality measure.

2. The system of claim 1, wherein the user interface includes a description of the quality measure.

3. The system of claim 1, wherein the user interface includes a link to a form in which to provide one or more of the data elements, wherein the data elements include documentation of completion of the quality measure or a reason for not completing the quality measure.

4. The system of claim 3, wherein the form includes one or more of a description of the quality measure, a quality measure completion section that includes a selectable option indicating completion or non-completion of the quality measure, a non-completion section that includes one or more selectable standard reasons for not completing the quality measure, a free text portion for receiving a non-standard reason for not completing the quality measure, and a qualifying data section that provides one or more of the data elements associated with the quality measure from the patient's electronic medical record.

5. The system of claim 1, wherein the completion status of the quality measure includes one or more of incomplete, complete-incomplete, and complete, and wherein the incomplete status indicates that no data elements indicating completion of the quality measure are available, the complete-incomplete status indicates that one or more data elements indicating completion of the quality measure are available but that the data elements are not sufficient to document completion of the quality measure, and the complete status indicates that sufficient data elements indicating completion of the quality measure are available.

6. The system of claim 5, wherein the quality measure includes a required completion time and wherein the status of the quality measure is determined to be complete-incomplete or complete when the required completion time is elapsed.

7. The system of claim 1, wherein the user interface includes a link to a form in which to enter an order for the patient.

8. The system of claim 1, further comprising:
a condition determination component that determines a medical condition that applies to the patient based at least on patient data contained in the patient's electronic medical record.

9. The system of claim 1, further comprising:
a report generation component that generates a report that includes the quality measure and the one or more data elements associated with the quality measure.

10. The system of claim 1, wherein the quality measure is one of the National Hospital Inpatient Quality Measures as set forth by the Joint Commission.

11. A method for tracking completion of quality measures in a healthcare system, the method comprising:
determining, via a first computing device having a processor and a memory, one or more quality measures that are applicable to a patient based on a medical condition of the patient;
identifying one or more data elements from a database that are associated with the one or more quality measures and that values for which, when provided, document completion of the one or more quality measures;
determining a completion status of each of the one or more quality measures based at least on patient data in a patient's electronic medical record; and
generating, via a second computing device having an associated display device, a user interface to present to a clinician, the user interface providing indications of the one or more quality measures and the completion status of each of the one or more quality measures, wherein the first and second computing devices are the same or different device.

12. The method of claim 11, further comprising:
receiving one or more data elements associated with an event in the patient's care; and
updating the completion status of one or more of the quality measures.

13. The method of claim 11, further comprising:
generating a report that provides indications of at least the one or more quality measures and one or more of the data elements that are associated with the one or more quality measures.

14. The method of claim 11, further comprising:
determining the medical condition of the patient based at least partially on patient data entered in the patient's electronic medical record.

15. One or more computer-readable media having computer-executable instructions embodied thereon that, when executed, provide a component for presenting a quality measure that applies to a patient, the component comprising:
a data gathering portion that gathers data from a patient's electronic medical record, the data including a medical condition of the patient and one or more data elements associated with a quality measure that applies to the patient's medical condition;
a decision engine that determines, via a computing device having a processor, the quality measure that applies to the patient's medical condition and the one or more data elements associated with the quality measure, wherein acceptable values for each of the one or more data elements must be provided by clinicians in a healthcare system in order to document compliance with the quality measure;
a presentation portion that presents a user interface to one or more of the clinicians in the healthcare system, the user interface including an indication of the medical condition of the patient, an indication of the quality measure, and an indication of a status of completion of the quality measure, wherein completion of the quality measure is determined based on the presence of acceptable values for each of the one or more data elements associated with the quality measure.

16. The media of claim 15, wherein the component is portable and can be implemented in a variety of healthcare system applications.

17. The media of claim 15, wherein the user interface is a hypertext markup language (HTML) document that is presented on a web page.

18. The media of claim 17, wherein the web page is a portal page that is provided to a clinician when viewing the patient's electronic medical record.

19. The media of claim 15, wherein the component provides a warning to a user prior to, or at a time of discharge of the patient from the healthcare system, the warning indicating one or more quality measures for which the status of completion is at least partially incomplete.

20. The media of claim 15, wherein a plurality of quality measures apply to the patient's medical condition, and wherein the user interface includes an overall completion status indicator, the overall completion indicator including a shape that has an interior portion, and the interior portion of the shape is not filled in when none of the plurality of quality measures are complete, the interior portion is partially filled in when one or more of the plurality of quality measures are complete, and the interior portion is fully filled in when all of the plurality of quality measures that apply to the patient are complete.
